(19) United States
(12) Patent Application Publication
(10) Pub. No.: US 2013/0325940 A1
(43) Pub. Date: Dec. 5, 2013

(54) Geomessaging Server and Client for Relaying Event Notifications via a VANET

(71) Applicant: George Foti, Dollard des Ormeaux (CA)

(72) Inventor: George Foti, Dollard des Ormeaux (CA)

(73) Assignee: TELEFONAKTIEBOLAGET L M ERICSSON (PUBL), Stockholm (SE)

(21) Appl. No.: 13/482,516

(22) Filed: May 29, 2012

(51) Int. Cl. H04W 8/00; G06F 15/16

(52) U.S. Cl. 709/204

(57) ABSTRACT

Embodiments include a geomessaging server and a geomessaging client for use in a cooperative intelligent transportation system. The server sends an event notification message, via an infrastructure-based wireless communication network, to a geomessaging client associated with a vehicle that is located within a targeted one of multiple defined geographical areas. This message indicates the occurrence of an event pertinent to travel conditions in the targeted area. The server also generates a message relay request that solicits the geomessaging client to relay the message to any other vehicles within the vehicle's vicinity via a vehicular ad-hoc wireless communication network. The sever then sends the generated request to the client via the infrastructure-based network. In at least some embodiments, the geomessaging client relays the message accordingly responsive to receiving the request. This way, the other vehicles will advantageously receive the event notification message even if they are not connected to the server.

### TECHNICAL FIELD

The present invention generally relates to a geomessaging server and a geomessaging client for use with a cooperative intelligent transportation system, and particularly relates to a geomessaging server and client for relaying event notifications via a vehicular ad-hoc network (VANET).

### BACKGROUND

An intelligent transportation system (ITS) provides vehicle operators with a wealth of information that enables the operators to make informed decisions about how they operate their vehicles. Information provided by an ITS may for instance notify an operator about the occurrence of an event that is pertinent to travel conditions in the area of his or her vehicle, such as the occurrence of traffic, an accident, hazardous road conditions, or the like.

In order for an ITS to provide this information to vehicle operators, vehicles are equipped with sensors and other information sources that detect the occurrence of these events. The information sources may detect, for instance, a low speed indicative of heavy traffic, an impact characteristic of an accident, or the skidding of a vehicle's tires on a slippery surface. The detecting vehicle then generates an event notification message and transmits that message to surrounding vehicles via short-range wireless communications (e.g., dedicated short-range communications in the 5.9 Ghz band). Vehicles that receive the event notification message propagate the message to other vehicles, as appropriate, so as to form a vehicular ad-hoc wireless communication network (VANET).

This VANET, however, limits the ITS in some respects. As the population of ITS-enabled vehicles increases, the spectrum used for the VANET will become congested. The congestion will delay event notification message propagation and will therefore threaten the effectiveness of the ITS to provide event notification in a timely fashion. Furthermore, because the VANET relies on vehicle presence for message propagation, the VANET often only propagates event notifications to vehicles within the immediate area of an event.

These VANET limitations have prompted so-called cooperative ITSs (C-ITSs) that employ both a VANET and an infrastructure-based wireless communication network in a cooperative fashion. An infrastructure-based network in this regard includes for instance a cellular communication network (e.g., a Long Term Evolution, LTE, network, a High Speed Packet Access, HSPA, network, etc.) or any similar network that employs infrastructure for routing communications between communication endpoints. In such a C-ITS, a vehicle detecting the occurrence of an event transmits an event notification message to surrounding vehicles via the VANET, but also transmits the message to a geomessaging server via the infrastructure-based network. The geomessaging server in turn determines the geographical area(s) over which the event notification message is relevant (e.g., areas outside of the immediate vicinity of the event), and sends the message to the vehicles within those targeted areas via the infrastructure-based network.

Problematically, though, vehicles within the targeted area will not receive the event notification message, even if they would have been able to receive the message via a VANET had they been near the event, if they are not configured to communicate with a geomessaging server. A vehicle may not be configured to communicate with a geomessaging server if it is not connected to the infrastructure-based network, e.g., because either the vehicle is not equipped with an interface capable of connecting to that network or the vehicle operator declines to pay for a subscription to the network. Or, even if the vehicle is connected to an infrastructure-based network, the vehicle may still not be able to communicate with a geomessaging server if that network does not implement such a server.

### SUMMARY

One or more embodiments herein include a geomessaging server and a geomessaging client for use in a cooperative intelligent transportation system (C-ITS). A geomessaging client associated with a vehicle receives an event notification message from the geomessaging server via an infrastructure-based wireless communication network. The geomessaging client advantageously relays that message to any other nearby vehicles via a vehicular ad-hoc wireless communication network. This way, the other vehicles will receive the event notification message even if they are not connected to the geomessaging server, e.g., because they are not connected to the infrastructure-based network.

More particularly, embodiments herein include a method performed by a geomessaging server for use in a C-ITS. The method includes sending an event notification message, via an infrastructure-based wireless communication network, to a geomessaging client associated with a vehicle that is located within a targeted geographical area out of multiple defined geographical areas serviced by the geomessaging server. This event notification message indicates the occurrence of an event pertinent to travel conditions in the targeted area.

The method performed by the geomessaging server further includes generating a message relay request that solicits the geomessaging client to relay the message to any other vehicles within the vehicle's vicinity via a vehicular ad-hoc wireless communication network. Finally, the method includes sending the generated request to the geomessaing client via the infrastructure-based wireless communication network.

In one or more embodiments, the method further comprises sending the message, via the infrastructure-based wireless communication network, to each geomessaging client registered with the geomessaging server as being associated with a vehicle located within the targeted area. Such may entail sending the message via a broadcast channel or via a number of unicast channels. Regardless, the method in some embodiments includes sending the message relay request to each of these registered geomessaging clients via the infrastructure-based network.

In other embodiments, by contrast, the method includes selecting a subset of the registered geomessaging clients, and selectively sending the request to the subset of geomessaging clients via the infrastructure-based network. In one embodiment, for example, the method comprises selecting this subset to exclude substantially co-located vehicles. In another embodiment, the subset is selected based on maximizing the geographical range over which the message is relayed via the vehicular ad-hoc wireless communication network, while minimizing traffic sent via the infrastructure-based network.

Regardless, in at least some embodiments, the vehicular ad-hoc wireless communication network employs dedicated short-range communications.

Embodiments herein also include a method performed by a geomessaging client for use in a C-ITS. Again, a geomessaging client in this regard is associated with a vehicle located within a first one of multiple defined geographical areas serviced by a geomessaging server. The method includes receiving an event notification message from the geomessaging server via an infrastructure-based wireless communication network. As above, the event notification message indicates the occurrence of an event pertinent to travel conditions in the first area. The method further entails relaying the message via a vehicular ad-hoc wireless communication network to any other vehicles within the vehicle's vicinity. In some embodiments, the message is relayed via dedicated short-range communications.

In at least some embodiments, this relaying is performed responsive to receiving a message relay request associated with the event notification message. In one embodiment, this message relay request is received from the geomessaging server via the infrastructure-based network.

Embodiments herein further include corresponding apparatus for the geomessaging server and the geomessaging client.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of a cooperative intelligent transportation system (C-ITS) that includes a geomessaging server and a geomessaging client configured according to one or more embodiments.

FIG. 2 illustrates an example of selectively sending a message relay request to a subset of geomessaging clients registered with the geomessaging server according to one or more embodiments.

FIG. 3 is a block diagram of a C-ITS that is based on an IP Multimedia Subsystem (IMS) architecture according to one or more embodiments.

FIG. 4A is a call flow diagram of a session initiation procedure according to one or more embodiments.

FIG. 4B is a call flow diagram of a location update procedure according to one or more embodiments.

FIG. 4C is a call flow diagram of a procedure for relaying an event notification message according to one or more embodiments.

FIG. 5 is a logic flow diagram of a method performed by a geomessaging server for use in a C-ITS according to one or more embodiments.

FIG. 6 is a logic flow diagram of a method performed by a geomessaging client for use in a C-ITS according to one or more embodiments.

### DETAILED DESCRIPTION

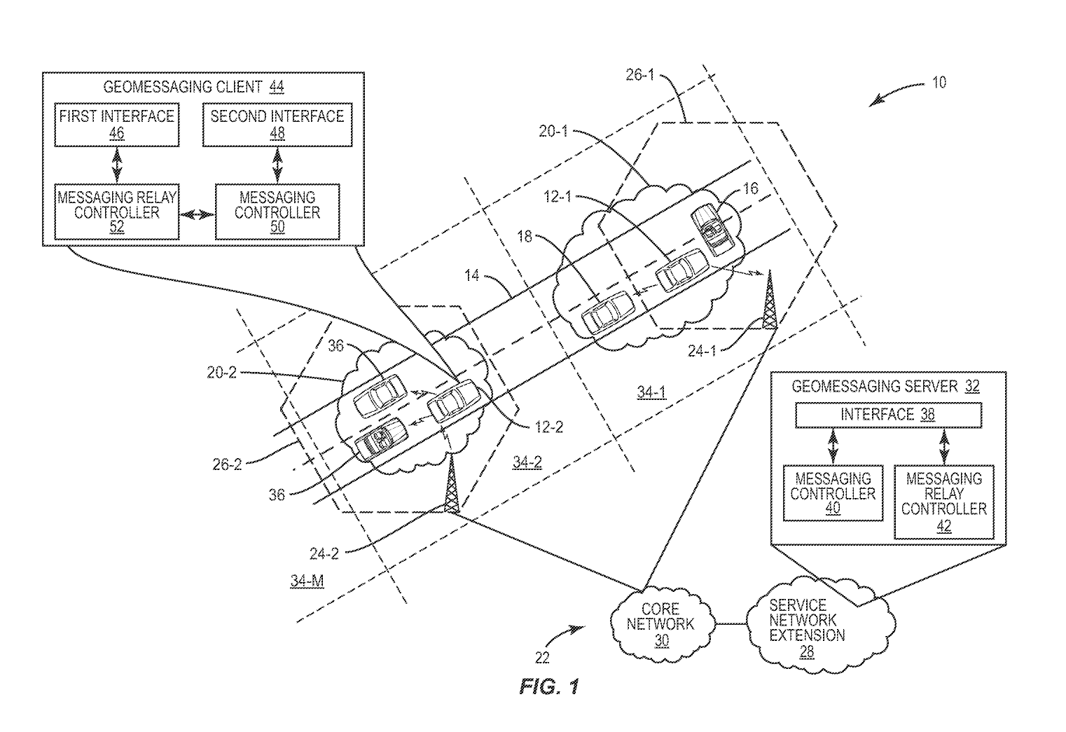

FIG. 1 depicts a cooperative intelligent transportation system (C-ITS) 10 according to one or more embodiments. The C-ITS 10 serves a plurality of vehicles 12 along a roadway 14, including vehicle 12-1 and vehicle 12-2, by providing the operators of those vehicles 12 with information that enables the operators to make informed decisions about how they operate their vehicles 12. Of particular relevance herein, at least some of the information provided by the C-ITS 10 notifies the operators of the vehicles 12 about the occurrence of events that are pertinent to travel conditions in the area, such as the occurrence of traffic, a collision, hazardous road conditions, or the like.

In general, the C-ITS 10 notifies vehicles in the immediate vicinity of an event about that event via a vehicular ad-hoc wireless communication network (VANET). Consider the example shown in FIG. 1. As shown, vehicle 12-1 collides with another vehicle 16 on the road 14. Vehicle 12-1 is equipped with one or more sensors that detect the impact of this collision. When the one or more sensors detect the collision, vehicle 12-1 generates an event notification message that indicates the occurrence of the collision and then transmits that message directly to any nearby vehicles 18 via VANET 20-1. Vehicles 18 that receive the event notification message propagate the message directly to other vehicles, as appropriate, via the VANET 20-1.

Problematically, though, if the wireless communication spectrum used by a VANET is congested, propagation of an event notification message may be unacceptably delayed. And because a VANET utilizes short-range wireless communications (e.g., dedicated short-range communications in the 5.9 Ghz band), the VANET may not be capable of propagating the event notification message to other vehicles outside the immediate vicinity of the event (e.g., vehicle 12-2 in FIG. 1's example), even if the event affects the travel conditions where those vehicles are located.

The C-ITS 10 addresses these limitations of a VANET by propagating event notification messages cooperatively via a VANET and an infrastructure-based wireless communication network 22. FIG. 1 depicts this infrastructure-based network 22 as a cellular network consisting of a plurality of base stations 24-1, 24-2, . . . 24-N that provide wireless communication coverage for respective cells 26-1, 26-2, . . . 26-N and that provide access to a service network extension 28 via a core network 30. The cooperative nature of message propagation via a VANET and network 22 entails distributing event notification messages via both a VANET and the infrastructure-based network 22. In general, messages propagate to vehicles in the immediate vicinity of an event (e.g., vehicle 18) via a VANET and propagate to vehicles outside that immediate vicinity (e.g., vehicle 12-2) via the infrastructure-based network 22.

An event notification message distributed via the infrastructure-based network 22 is sent to a geomessaging server 32 in the service network extension 28. Appropriately named, the geomessaging server 32 selectively distributes the event notification message to vehicles 12 within targeted geographical areas where travel conditions are affected by the indicated event. In this regard, the geomessaging server 32 logically divides the geographical area it services into multiple defined geographical areas 34-1, 34-2, . . . 34-M (distinct from the cells 26 covered by base stations 24) and tracks the vehicles 12 that are located within any given area 34-m at any given time. After the server 32 receives an event notification message, the server 32 obtains information that indicates the defined areas 34 where travel conditions are affected by the indicated event. The server 32 then determines which vehicles 12 are within the affected area(s) 34 based on its area-by-area tracking of vehicle locations, and sends an event notification message to those vehicles 12 via the infrastructure-based network 22. The geomesassing server 32 for instance sends messages to the vehicles 12 via the infrastructure-based network 22 using IP addresses for those vehicles 12.

For example, the vehicle 12-1 in FIG. 1 that collided with vehicle 16 sends the event notification message to nearby vehicles 18 via the VANET 20-1, but also sends the message to the geomessaging server 32 via the infrastructure-based network 22. Based on this event notification message, the geomessaging server 32 obtains information indicating that travel conditions within defined geographical area 34-2 are affected by the collision. Having tracked the location of vehicle 12-2 on an area-by-area basis, the geomessaging server 32 identifies vehicle 12-2 as being located within the affected area 34-2 and therefore sends an event notification message indicating the occurrence of the collision to that vehicle 12-2. The geomessaging server 32 sends this message to the vehicle 12-2 via the infrastructure-based network 22 (i.e., via core network 30 and base station 24-2).

Embodiments herein contemplate that one or more of the vehicles 36 within the affected area 34-2 are not configured to communicate with the geomessaging server 32. These vehicles 36, for example, are not connected to any infrastructure-based network, e.g., because the vehicles 36 are not equipped with interfaces to such a network or the vehicles' operators declined to pay for a subscription to such a network. Or, the vehicles 36 are connected to some infrastructure-based network other than network 22, but that network does not implement a geomessaging server. Regardless of the reason why these vehicles 36 are not configured to communicate with the geomessaging server 32, they will not receive the event notification message from the geomessaging server 32 indicating the occurrence of the collision. This remains the case even though the vehicles 36 would have been able to receive an event notification via VANET 20-1 had they been near the collision; that is, the vehicles 36 are configured to communicate with a VANET, but are not configured to communicate with the infrastructure-based network 22. Notably, even though these one or more vehicles 36 will not receive the event notification message from the geomessaging server 32 via the infrastructure-based network 22, the vehicles 36 in one or more embodiments herein will nonetheless receive the message as relayed via a VANET 20-2 from another vehicle 12-2 that did.

More particularly, the geomessaging server 32 according to one or more embodiments comprises an interface 38, a messaging controller 40, and a messaging relay controller 42. The interface 38 is configured to communicatively couple the server 32 to the infrastructure-based network 22. The messaging controller 40 is configured to send an event notification message, via the interface 38, to a geomessaging client 44 associated with a vehicle 12-2 that is located within a targeted geographical area 34-2 out of multiple defined geographical areas 34 serviced by the geomessaging server 32. This message indicates the occurrence of an event (e.g., a collision) pertinent to travel conditions in the targeted area 34-2.

The messaging relay controller 42 is configured to generate a message relay request that solicits the geomessaging client 44 associated with vehicle 12-2 to relay the event notification message to any other vehicles 36 within the vehicle's vicinity via a VANET 20-2. The messaging relay controller 42 then sends the generated request to the geomessaging client 44 via the interface 38; that is, via the infrastructure-based network 22.

A geomessaging client 44 associated with vehicle 12-2 comprises a first interface 46, a second interface 48, a messaging controller 50, and a messaging relay controller 52. The first interface 46 is configured to communicatively couple the geomessaging client 44 to the VANET 20-2. The second interface 48, by contrast, is configured to communicatively couple the geomessaging client 44 to the infrastructure-based network 22.

The messaging controller 50 is configured to receive the event notification message from the geomessaging server 32 via the second interface; that is, via the infrastructure-based network 22. As noted above, this message indicates the occurrence of an event (e.g., a collision) pertinent to travel conditions in area 34-2. The messaging relay controller 52 is configured to relay the message via the first interface 46 to any other vehicles 36 within the vehicle's vicinity. Thus, even though other vehicles 36 within the vehicle's vicinity may not receive the event notification message from the geomessaging server 32 via the infrastructure-based network 22, the messaging relay controller 52 advantageously relays such a message to those vehicles 36 via the VANET 20-2.

In at least some embodiments, the messaging relay controller 52 relays the event notification message responsive to receiving a message relay request associated with that event notification message. In one embodiment, for example, the messaging relay controller 52 receives the message relay request from the geomessaging server 32 via the second interface 48, i.e., via the infrastructure-based network 22. For example, the message relay request is embedded or otherwise included within the event notification message received from the geomessaging server 32, e.g., as a flag. In other embodiments, though, the message relay request is received in a message separate from the event notification message.

In one or more embodiments, geomessaging clients associated with vehicles in the C-ITS 10 register with the geomessaging server 32 in order to assist the server 32 in tracking the vehicles' locations on an area-by-area basis. For example, a geomessaging client is configured to receive information from the geomessaging server 32 indicative of the geographical coordinates of the defined area 34 in which the client's associated vehicle is located. The geomessaging client then monitors for and updates the geomessaging server 32 when the vehicle leaves that defined area 34 according to the received information. In sending the geomessaging server 32 the location update, the geomessaging client effectively registers with the server 32, which in turn responds back with information indicative of the geographical coordinates of the new defined area 34 in which the client's vehicle is now located.

In at least some embodiments, the messaging controller 40 of the geomessaging server 32 is configured to send the event notification message, via the interface 38, to each geomessaging client registered with the server 32 as being associated with a vehicle located within the targeted area 34-2. In other words, the messaging controller 40 effectively broadcasts the event notification message to all vehicles 12 it knows are located within the targeted area 34-2, e.g., via a broadcast transmission or via multiple unicast transmissions.

In embodiments where geomessaging clients relay event notifications in response to message relay requests from the geomessaging server 32, the messaging relay controller 42 in some of those embodiments is configured to send the message relay request to each geomessaging client registered with the server 32 as being associated with a vehicle located within the targeted area 34-2. In this case, the messaging relay controller 42 maximizes the geographical range over which the event notification message is relayed via the VANET 20-2.

In other ones of these embodiments, by contrast, the messaging relay controller 42 is configured to select a subset of these registered geomessaging clients, and to selectively send the request to that subset of clients via the interface 38. Selectively sending the message relay request to only some of the registered clients advantageously reduces the amount of traffic sent over the infrastructure-based network 22, albeit at the expense of excluding some geographic range over which the message is to be relayed and thereby potentially depriving some vehicles 36 of receiving a relayed message.

That said, the messaging relay controller 42 in at least one embodiment intelligently selects the subset of registered clients to which the request is to be sent, based on maximizing the geographical range over which the message is relayed via the VANET 20-2, while minimizing the amount of traffic sent via the infrastructure-based network 22. For example, in one embodiment the messaging relay controller 42 selects the subset to exclude geomessaging clients associated with substantially co-located vehicles. That is, the subset is selected to include as many registered geomessaging clients as possible (so as to maximize relay coverage) without including registered clients associated with substantially co-located vehicles.

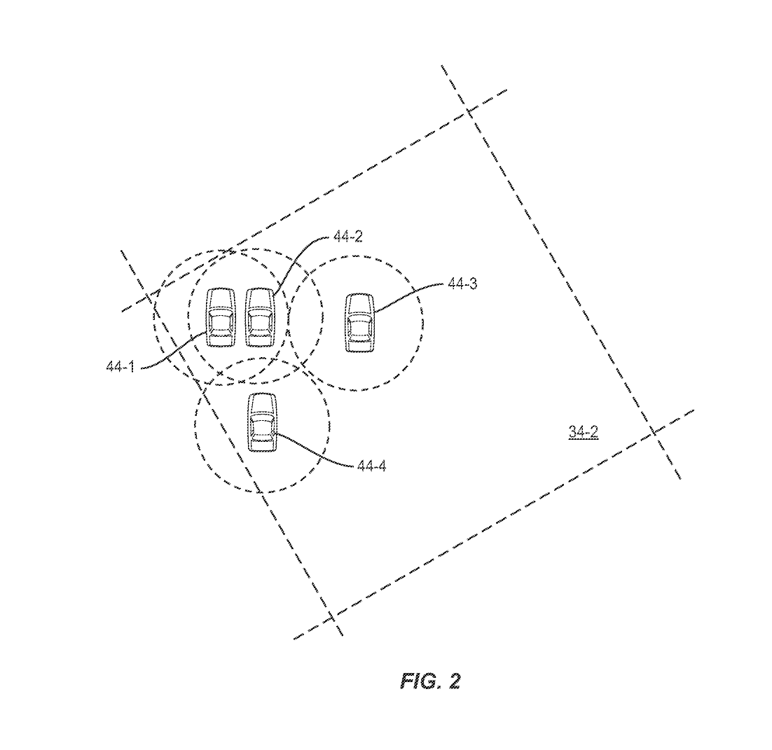

FIG. 2 illustrates a simple example of this.

As shown in FIG. 2, the set of geomessaging clients that are registered with the geomessaging server 32 as being associated with vehicles located within a defined area 34-2 include clients 44-1, 44-2, 44-3, and 44-4. Clients 44-1 and 44-2 however are associated with vehicles that are substantially co-located, at least in the sense that the geographic range over which the clients 44-1 and 44-2 would relay event notification messages substantially overlap. Moreover, any additional geographic range over which client 44-2 would relay messages is substantially covered by other clients 44-3 and 44-4. Accordingly, based on this overlap in relay coverage, the messaging relay controller 42 selects the subset to exclude client 44-2; that is, the controller 42 selects the subset to include clients 44-1, 44-3, and 44-4.

Those skilled in the art will appreciate that no particular communication technology or standard is required for practicing the above mentioned embodiments. For example, the infrastructure-based wireless communication network 22 may comprise any network that employs infrastructure for routing communications between communication endpoints, as opposed to ad-hoc networks that do not employ such routing infrastructure and instead rely on communication endpoints themselves for such routing. In embodiments where the infrastructure-based network 22 comprises a cellular network, the network 22 may implement any number of possible cellular technologies, including for instance technologies based on Long Term Evolution, LTE, High Speed Packet Access, HSPA, or the like.

Similarly, a VANET 20 herein may comprise any ad-hoc wireless communication network amongst vehicles. A VANET 20 may therefore implement any number of possible short-range wireless communication standards or protocols, including for instance dedicated short-range wireless communications in the 5.9 Ghz band, IEEE 802.11, Bluetooth, or the like. The VANET 20 may also use the geonetworking protocol as defined in ITS specifications.

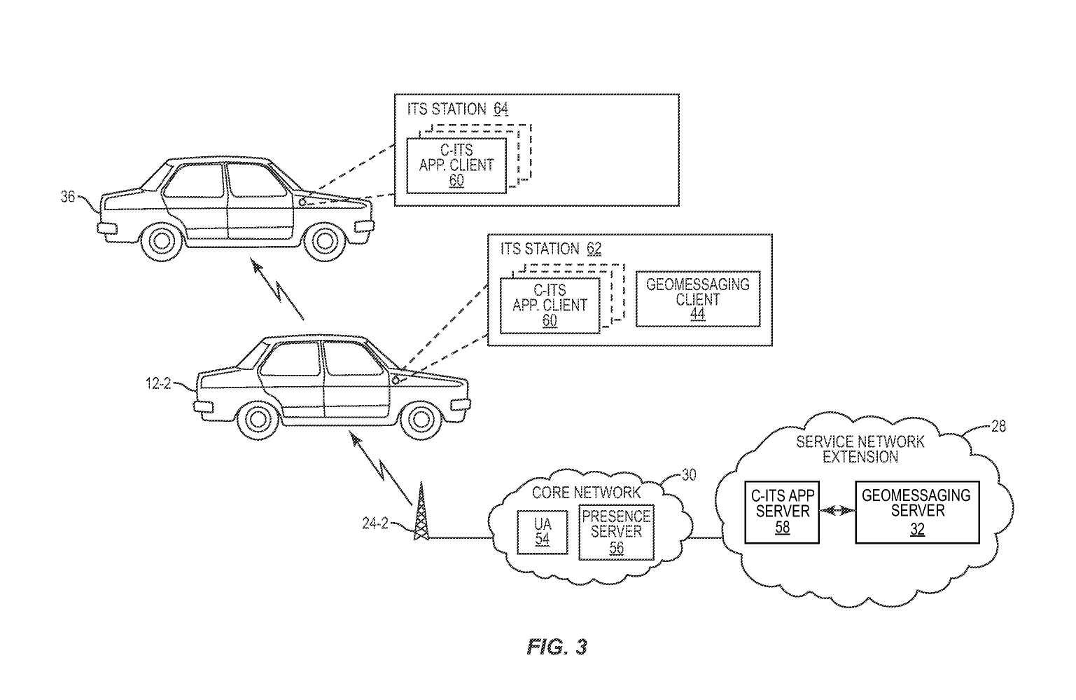

With the above variations and modifications in mind, FIG. 3 illustrates one or more embodiments where the infrastructure-based network 22 implementation is based on an IP Multimedia Subsystem (IMS) architecture. In this case, the core network 30 includes the IMS core network, an HTTP/IMS User Agent (UA) 54, and a Presence Server 56. Furthermore, the geomessaging server 32 effectively serves as a proxy for a C-ITS application server 58 in the service network extension 28. The C-ITS application server 58 communicates with one or more (C-)ITS application clients 60 associated with any given vehicle 12, 36.

More particularly, the C-ITS application server 58 receives information from a plurality of sources, including vehicles, road side units, as well as external information. The server 58 aggregates and consolidates this information in order to correlate events based on time, location, and event type. In this way, the server 58 derives a holistic picture of events within the coverage area of the C-ITS 10. For example, if an unfortunate vehicle pile-up were to occur, the C-ITS application server 58 would receive numerous event notification messages (e.g., decentralized environmental notification messages, DENMs) about that event from nearly the same location and at nearly the same time. Rather than naively responding multiple times to each received message individually, the C-ITS application server 58 intelligently responds to the single event indicated by those messages. In this regard, the C-ITS application server 58 determines information to be disseminated in view of that event and the geographical area over which to provide that information. The server 58 then sends an event notification message with this information to the geomessaging server 32 so that the geomessaging server 58 can distribute the message to vehicles 12, such as vehicle 12-2, within that geographical area.

The geomessaging server 58 distributes the message in this way based on its logical division of the geographical area into defined areas 34 and its tracking of vehicles 12 on an area-by-area basis as described above. Vehicle tracking in particular is assisted by the UA 54 and Presence Server 56 in the core network 30. Specifically, the geomessaging client 44 associated with vehicle 12-2 sends a location update to the UA 54 when the vehicle 12-2 exits a defined area 34. The UA 54 correspondingly publishes this location update to the Presence Server 56, which notifies the geomessaging server 32. The geomessaging server 32 then informs the geomessaging client 44 of the coordinates for the defined area 34 it is entering.

The geomessaging server 58 supports multiple addressing schemes for distribution of event notification messages, including unicast and broadcast. In the case of unicast distribution, each vehicle 12 within a defined area 34 to which the message is to be sent receives the message through an individual communication channel. In the case of broadcast distribution, by contrast, all vehicles belonging to a broadcast area are addressed collectively, rather than individually. Hence, transmissions using broadcast channels are more efficient for a large number of recipients.

Regardless of the particular scheme used for message distribution, the geomessaging server 58 in FIG. 3 distributes an event notification message and a message relay request to the geomessaging client 44 associated with vehicle 12-2. The geomessaging client 44, along with one or more C-ITS application clients 60, comprise an ITS station 62 for the vehicle 12-2. The geomessaging client 44 in this regard is responsible for communication between the one or more C-ITS application clients 60 and the geomessaging server 32. The geomessaging client 44 serves in this role by establishing a session with the infrastructure-based network 22 prior to exchanging any data with the network 22 related to the clients 60. Following establishment of this session and upon receiving the message and request from the geomessaging server 32, the geomessaging client 44 provides the message to a targeted one of the C-ITS application clients 60 and also provides the message to the first interface 46 for broadcasting the message via VANET 20-2.

As shown, a vehicle 36 receives the relayed message via VANET 20-2. The vehicle 36 is not configured to connect to the geomessaging server 32 because the vehicle's ITS station 64 does not implement a geomessaging client. Despite not being configured to connect to the geomessaging server 32, one or more of the vehicle's ITS applications 60 still receive the event notification message sent by the geomessaging server 32 because the applications 60 receive the message when it is relayed by vehicle 12-2 via VANET 20-2.

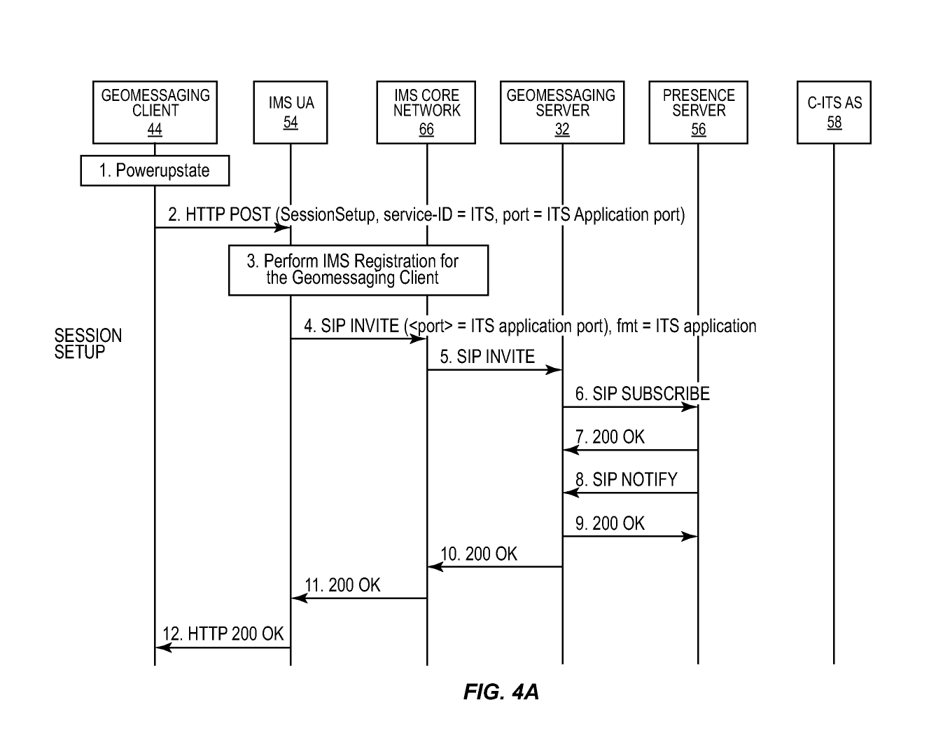

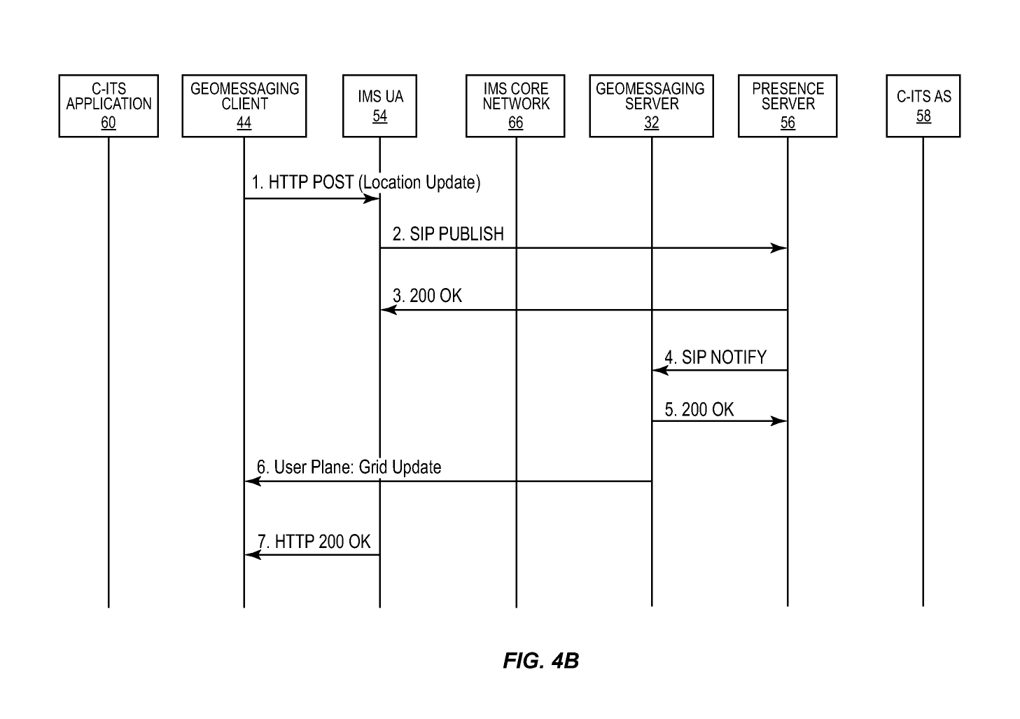

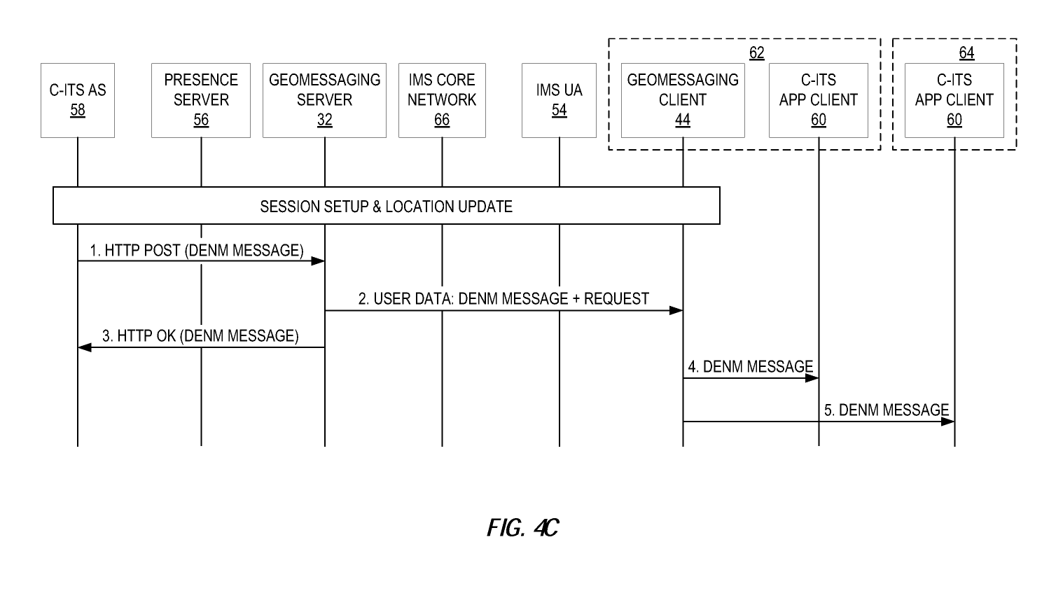

FIGS. 4A-4C illustrate additional details of the above embodiments in the case that the C-ITS employs the Session Initiation Protocol (SIP) and the Hypertext Transport Protocol (HTTP). SIP is a textual-based protocol used to set up, modify, and teardown sessions. HTTP is an application protocol that functions as a request-response protocol in the client-server context.

In these embodiments, vehicle 12-2 executes multiple different applications. These different applications include one or more C-ITS applications 60 as well as zero or more non-ITS application clients. A non-ITS application client in this regard provides the vehicle operator with location-dependent information, but that information is not pertinent to travel conditions in the area. For example, a non-ITS application client provides the vehicle operator with advertisements targeted to the geographical location of the vehicle 12-2, such as the menu specials of nearby restaurants. Regardless, the geomessaging client 44 distinguishes between the different applications in order to provide differentiated charging and quality of service if needed. In order to distinguish between the different applications, the geomessaging client 44 allocates different port numbers to different applications. In at least some embodiments, the geomessaging client 44 further distinguishes between the different applications using different service identities for those applications. By distinguishing between applications in this way, different applications can provide information related to different geographical areas.

FIG. 4A depicts the procedure implemented by the geomessaging client 44 of vehicle 12-2 for registration and session initialization. As shown in FIG. 4A, power-up of a C-ITS application 60 triggers the geomessaging client 44 to initialize the procedure associated with such power-up, including registering with the IMS core network 66 and setting up an IMS session for data exchange (Step 1). In this regard, the geomessaging client 44 sends an HTTP POST request to the IMS UA 54 indicating that a session is being initiated for an ITS service (Step 2). The HTTP POST request includes a port number allocated to the C-ITS application 60. This port will be included in all C-ITS application data. Upon receiving the HTTP POST request, the IMS UA 54 performs IMS registration on behalf of the C-ITS application 60 identified in the request (Step 3). IMS registration is performed only once and is refreshed autonomously by the IMS UA 54.

Next, the IMS session is set up. The IMS UA 54 sends a SIP INVITE to the IMS core network 66 (Step 4). The Session Description Protocol (SDP) within the SIP INVITE is used to set up a TCP session for application data exchange between the geomessaging client 44 and the geomessaging server 32. The SDP includes the same port number as the one received from the geomessaging client 44 in the HTTP POST request, as well as the service identity. This allows the geomessaging server 32 to associate the application data received later with the proper C-ITS application server, which is server 58 in this case, since the geomessaging server 34 maintains a mapping between port number, service identity, and application server

The geomessaging server 32 receives the SIP INVITE as forwarded from the IMS core network 66 using IMS service control (Step 5). In response, the geomessaging server 32 subscribes to the presence server 56 by sending a SIP SUBSCRIBE to the presence server 56 (Step 6). This directs the presence server 56 to notify the geomessaging server 32 when the geomessaging client 44 associated with the vehicle 12-2 executing the C-ITS application 60 sends a location update to the network 22 as described above. After the presence server 56 acknowledges the geomessaging server's subscription in this regard by returning a SIP 200 OK response (Step 7), the presence server 56 proactively sends an initial indication of the vehicle's location by sending a SIP NOTIFY to the geomessaging server 32 (Step 8). The geomessaging server 32 acknowledges this indication by sending a SIP 200 OK response to the presence server 56 (Step 9) and then acknowledges the IMS core network's SIP INVITE by sending a SIP OK response to the IMS core network 66 (Step 10). At this point, the geomessaging server 32 has established a binding between the C-ITS application 60 data IP flow and the C-ITS application server 58 so that the geomessaging server 32 can proxy any data for that flow to the C-ITS application server 58. Finally, the IMS core network 66 returns a SIP 200 OK response to the IMS UA 54 (Step 11), which in turns sends an HTTP 200 OK response to the geomessaging client 44 (Step 12). With the session set up in this way, the geomessaging server 32 thereafter updates the geomessaging client 44 of the location of vehicle 12-2, as indicated by the presence server 56.

As the vehicle 22-3 moves, though, the geomessaging client 44 updates the geomessaging server 32 of vehicle 12-2's location as needed according to the processing shown in FIG. 4B. Specifically, when the geomessaging client 44 determines that vehicle 12-2 is leaving its current defined area 34, the geomessaging client 44 sends an HTTP POST request to the IMS UA 54 in order to inform the UA 54 of that event and to provide an update of its new location (Step 1). Responsive to receiving the location update contained in the HTTP POST request, the IMS UA 54 sends a corresponding SIP PUBLISH message to the Presence Server 56 (Step 2). The Presence Server 56 acknowledges that message by sending a 200 OK response (Step 3) and then informs the geomessaging server 32 about the vehicle's new location by sending a SIP NOTIFY message (Step 4}.

The geomessaging server 32 correspondingly acknowledges the location update received from the presence server 56 by sending a 200 OK response (Step 5). The geomessaging server 32 also determines, based on the new location of the vehicle 12-2, the coordinates of the new defined area 34 in which the vehicle 12-2 is located. The geomessaging server 32 sends the vehicle's geomessaging client 44 these coordinates by sending the client 44 a grid update via the user plane (Step 6). Finally, the IMS UA 54 sends an HTTP 200 OK response to the geomessaging client 44.

After session initiation in FIG. 4A, and after zero or more location updates according to FIG. 4B, the C-ITS application server 58 disseminates a DENM as an event notification message, via unicast, in the downlink direction according to FIG. 4C. As shown in FIG. 4C, the C-ITS application server 58 sends an HTTP POST to the geomessaging server 32 (Step 1). The C-ITS application server 58 includes in the HTTP POST the DENM as well as a geographical target for DENM dissemination. The geomessaging server 32 identifies all geomessaging clients associated with vehicles 12 located in the geographical target and forwards the DENM message to each of them. Moreover, according to one or more embodiments herein, the geomessaging server 32 sends one or more of those vehicles 12 a message relay request in order to solicit those vehicles 12 to relay the DENM message via a VANET 20-2. Accordingly, FIG. 4C shows that the geomessaging server 32 sends user data to the geomessaging client 44 associated with vehicle 12-2 that includes the DENM message and a message relay request (Step 2). The geomessaging server 32 then sends an HTTP OK message to the C-ITS application server 58 in order to close the HTTP transaction associated with DENM message dissemination (Step 3).

Upon receiving the user data from the geoemssaging server 32, the geomessaging client 44 determines to which C-ITS application 60 of the vehicle 12-2 the user data is directed. The geomessaging client 44 makes this determination based on the port number associated with the incoming user data. The geomessaging client 44 then sends the DENM to the determined C-ITS application 60 (Step 4). Responsive to the message relay request, the geomessaging client 44 also provides the message to the first interface 46 for broadcasting the message to any other nearby vehicles 36 via the VANET 20-2 (Step 5).

Those skilled in the art will appreciate that while FIG. 1 illustrates the defined geographic areas as fixed, rectangular tiles, the present invention is not so limited. In fact, the size of the defined areas 34 can vary from application to application and as such provides considerable flexibility for targeting the vehicles 12 of interest depending on the application. Further, the size of the defined areas 34 can vary over time, e.g., based on the type of event notification message to be disseminated, based on vehicle traffic density or patterns, or the like. Still further, the defined areas 34 in some embodiments are optimized with respect to the topology of the road 14, e.g., the areas 34 may be designed to follow the run of major roads.

Those skilled in the art will also appreciate that a vehicle as used herein includes any land-based mobile machine that transports people or cargo (e.g., a car, truck, motorcycle, etc.).

Those skilled in the art will further appreciate that the various “circuits” described may refer to a combination of analog and digital circuits, and/or one or more processors configured with software stored in memory and/or firmware stored in memory that, when executed by the one or more processors, perform as described above. One or more of these processors, as well as the other digital hardware, may be included in a single application-specific integrated circuit (ASIC), or several processors and various digital hardware may be distributed among several separate components, whether individually packaged or assembled into a system-on-a-chip (SoC).

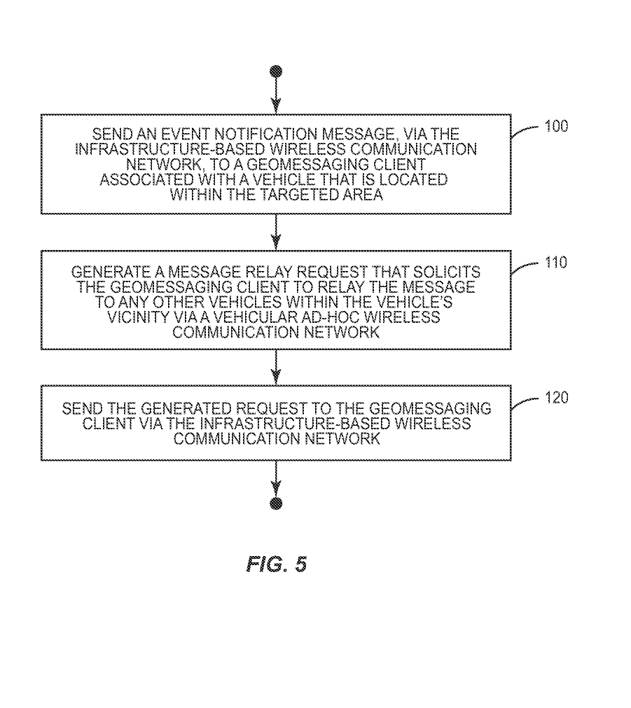

With the above variations and modifications in mind, those skilled in the art will appreciate that a geomessaging server 32 herein generally performs the processing shown in FIG. 5 for use in the C-ITS 10. As shown in FIG. 5, processing at the geomessaging server 32 includes sending an event notification message, via the infrastructure-based wireless communication network 22, to a geomessaging client 44 associated with a vehicle 12-2 that is located with a targeted one of multiple defined geographical areas 34-2 serviced by the geomessaging server 32 (Block 100). This message indicates the occurrence of an event (e.g., a collision) pertinent to travel conditions in the targeted area 34-2.

Processing at the geomessaging server 32 further entails generating a message relay request that solicits the geomessaging client 44 to relay the message to any other vehicles 36 within the vehicle's vicinity via a VANET 20-2 (Block 110). Finally, processing includes sending the generated request to the geomessaing client 44 via the infrastructure-based wireless communication network 22 (Block 120).

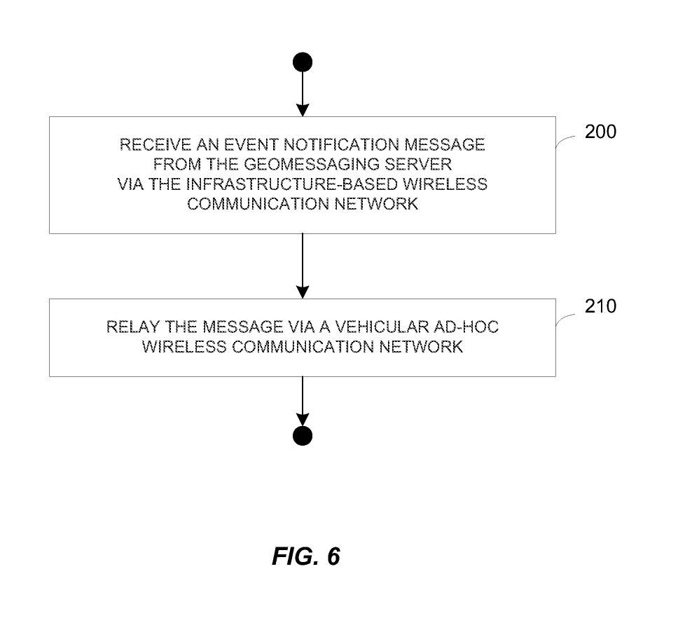

Those skilled in the art will also appreciate that FIG. 6 illustrates corresponding processing performed by the geomessaging client 44. As shown in FIG. 6, processing includes receiving the event notification message from the geomessaging server 32 via the infrastructure-based wireless communication network 22 (Block 200). Processing further entails relaying the message via VANET 20-2 to any other vehicles within the vehicle's vicinity (Block 210). In at least some embodiments, such relaying is performed responsive to receiving a message relay request associated with that message.

The present invention may of course be carried out in other ways than those specifically set forth herein without departing from essential characteristics of the invention. The present embodiments are to be considered in all respects as illustrative and not restrictive, and all changes coming within the meaning and equivalency range of the appended claims are intended to be embraced therein.

What is claimed is:

1. A method implemented by a geomessaging server for use in a cooperative intelligent transportation system, comprising:
sending an event notification message, via an infrastructure-based wireless communication network, to a geomessaging client associated with a vehicle that is located within a targeted one of multiple defined geographical areas serviced by the geomessaging server, the message indicating the occurrence of an event pertinent to travel conditions in the targeted area;
generating a message relay request that solicits the geomessaging client to relay the message to any other vehicles within the vehicle's vicinity via a vehicular ad-hoc wireless communication network; and
sending the generated request to the geomessaing client via the infrastructure-based wireless communication network.

2. The method of claim 1, further comprising sending the message, via the infrastructure-based wireless communication network, to each geomessaging client registered with the geomessaging server as being associated with a vehicle located within the targeted area.

3. The method of claim 2, further comprising sending the request to each of said registered geomessaging clients via the infrastructure-based wireless communication network.

4. The method of claim 1, further comprising selecting a subset of said registered geomessaging clients, and selectively sending the request to the subset of geomessaging clients via the infrastructure-based wireless communication network.

5. The method of claim 4, wherein said selecting comprises excluding substantially co-located vehicles from the subset.

6. The method of claim 4, wherein said selecting comprises selecting the subset based on maximizing the geographical range over which the message is relayed via the vehicular ad-hoc wireless communication network, while minimizing traffic sent via the infrastructure-based wireless communication network.

7. The method of claim 1, wherein the vehicular ad-hoc wireless communication network employs dedicated short-range communications.

8. A method implemented by a geomessaging client for use in a cooperative intelligent transportation system, wherein the geomessaging client is associated with a vehicle located within a first one of multiple defined geographical areas serviced by a geomessaging server, comprising:
receiving an event notification message from the geomessaging server via an infrastructure-based wireless communication network, wherein the event notification message indicates the occurrence of an event pertinent to travel conditions in the first area; and
relaying the message via a vehicular ad-hoc wireless communication network to any other vehicles within the vehicle's vicinity.

9. The method of claim 8, wherein said relaying is performed responsive to receiving a message relay request associated with the event notification message.

10. The method of claim 9, further comprising receiving the message relay request from the geomessaging server via the infrastructure-based wireless communication network.

11. The method of claim 8, wherein said relaying comprises relaying the message via dedicated short-range communications.

12. A geomessaging server for use in a cooperative intelligent transportation system, comprising:
an interface configured to communicatively couple the geomessaging server to an infrastructure-based wireless communication network;
a messaging controller configured to send an event notification message, via the interface, to a geomessaging client associated with a vehicle that is located within a targeted one of multiple defined geographical areas serviced by the geomessaging server, the message indicating the occurrence of an event pertinent to travel conditions in the targeted area; and
a messaging relay controller configured to generate a message relay request that solicits the geomessaging client to relay the message to any other vehicles within the vehicle's vicinity via a vehicular ad-hoc wireless communication network, and to send the generated request to the geomessaing client via the interface.

13. The geomessaging server of claim 12, wherein the messaging controller is configured to send the message, via the interface, to each geomessaging client registered with the geomessaging server as being associated with a vehicle located within the targeted area.

14. The geomessaging server of claim 13, wherein the messaging relay controller is configured to send the request to each of said registered geomessaging clients via the interface.

15. The geomessaging server of claim 13, wherein the messaging relay controller is configured to select a subset of said registered geomessaging clients, and to selectively send the request to the subset of geomessaging clients via the interface.

16. The geomessaging server of claim 15, wherein the messaging relay controller is configured to select the subset to exclude substantially co-located vehicles.

17. The geomessaging server of claim 15, wherein the messaging relay controller is configured to select the subset based on maximizing the geographical range over which the message is relayed via the vehicular ad-hoc wireless communication network, while minimizing traffic sent via the infrastructure-based wireless communication network.

18. The geomessaging server of claim 12, wherein the messaging relay controller is configured to generate the request to solicit the geomessaging client to relay the message via dedicated short-range communications.

19. A geomessaging client for use in a cooperative intelligent transportation system, wherein the geomessaging client is configured to be associated with a vehicle located within a first one of multiple defined geographical areas serviced by a geomessaging server, comprising:
a first interface configured to communicatively couple the geomessaging client to a vehicular ad-hoc wireless communication network;
a second interface configured to communicatively couple the geomessaging client to an infrastructure-based wireless communication network;
a messaging controller configured to receive an event notification message from the geomessaging server via the second interface, wherein the event notification message indicates the occurrence of an event pertinent to travel conditions in the first area; and
a messaging relay controller configured to relay the message via the first interface to any other vehicles within the vehicle's vicinity.

20. The geomessaging client of claim 19, wherein the messaging relay controller is configured to relay the message responsive to receiving a message relay request associated with the event notification message.

21. The geomessaging client of claim 20, wherein the messaging relay controller is configured to receive the message relay request from the geomessaging server via the second interface.

22. The geomessaging client of claim 19, wherein the first interface is configured to communicatively couple the geomessaging client to the vehicular ad-hoc wireless communication network via dedicated short-range communications.
